(19) United States
(12) Patent Application Publication
(10) Pub. No.: US 2024/0014464 A1
(43) Pub. Date: Jan. 11, 2024

(54) Battery Pack and Device Including the Same

(71) Applicant: LG Energy Solution, Ltd., Seoul (KR)

(72) Inventors: Byung Do Jang, Daejeon (KR); Hyoungsuk Lee, Daejeon (KR); Donghyun Kim, Daejeon (KR); Juhwan Shin, Daejeon (KR); Yongho Chun, Daejeon (KR)

(73) Assignee: LG Energy Solution, Ltd., Seoul (KR)

(21) Appl. No.: 18/036,195

(22) PCT Filed: Aug. 5, 2022
(86) PCT No.: PCT/KR2022/011658

§ 371 Date: May 10, 2023

(30) Foreign Application Priority Data
Aug. 17, 2021 (KR) 10-2021-0107934

(51) Int. Cl. H01M 10/6557; H01M 10/613; H01M 50/224; H01M 50/204

(52) U.S. Cl. CPC H01M 10/6557; H01M 10/613; H01M 50/224; H01M 50/204; H01M 10/625

(57) ABSTRACT

A battery pack includes a battery module including a plurality of battery cells, a pack frame that houses the battery module, a pack coolant pipe assembly that is connected to the battery module, and a pack coolant pipe housing that houses the pack coolant pipe assembly therein and includes a lower part configurable between an open position and a closed position.

### CROSS-REFERENCE TO RELATED APPLICATIONS

The present application is a national phase entry under 35 U.S.C. § 371 of International Application No. PCT/KR2022/011658 filed on Aug. 5, 2022, which claims the benefit of Korean Patent Application No. 10-2021-0107934 filed on Aug. 17, 2021 with the Korean Intellectual Property Office, the entire contents of which are incorporated herein by reference.

### TECHNICAL FIELD

The present disclosure relates to a battery pack and a device including the same, and more particularly, to a battery pack having enhanced cooling performance and a device including the same.

### BACKGROUND

In modern society, as portable devices such as a mobile phone, a notebook computer, a camcorder and a digital camera has been daily used, the development of technologies in the fields related to mobile devices as described above has increased. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuels. Therefore, the demand for development of secondary batteries is growing.

Currently commercialized secondary batteries include a nickel cadmium battery, a nickel hydrogen battery, a nickel zinc battery, and a lithium secondary battery. Among these, the lithium secondary battery has come into the spotlight because it has particular advantages, for example, hardly exhibiting memory effects compared to nickel-based secondary batteries and thus being freely charged and discharged, and having very low self-discharge rate and high energy density.

Such lithium secondary batteries mainly use a lithium-based oxide and a carbonaceous material as a cathode active material and an anode active material, respectively. The lithium secondary battery includes an electrode assembly in which a cathode plate and an anode plate, each being coated with the cathode active material and the anode active material, are arranged with a separator being interposed between them, and a battery case which seals and houses the electrode assembly together with an electrolytic solution.

Generally, the lithium secondary battery may be classified based on the shape of the exterior material into a can-type secondary battery in which the electrode assembly is mounted in a metal can, and a pouch-type secondary battery in which the electrode assembly is mounted in a pouch of an aluminum laminate sheet.

In the case of a secondary battery used for small-sized devices, two to three battery cells are arranged, but in the case of a secondary battery used for a middle- or large-sized device such as an automobile, a battery module in which a large number of battery cells are electrically connected is used. In such a battery module, a large number of battery cells are connected to each other in series or parallel to form a cell assembly, thereby improving capacity and output. One or more battery modules can be mounted together with various control and protection systems such as a BMS (battery management system) and a cooling system to form a battery pack.

When the temperature of the secondary battery rises higher than an appropriate temperature, the performance of the secondary battery may be deteriorated, and in the worst case, there is also a risk of an explosion or ignition. In particular, a large number of secondary batteries, that is, a battery module or a battery pack having battery cells, can add up the heat generated from the large number of battery cells in a narrow space, so that the temperature can rise more quickly and excessively. In other words, a battery pack equipped with a battery module in which a large number of battery cells are stacked can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

Moreover, in the case of a middle or large-sized battery module included in a vehicle battery pack, the battery module may be frequently exposed to direct sunlight and may be placed under high-temperature conditions such as summer or desert areas.

Therefore, when configuring a battery module or battery pack, it may be very important to ensure stable and effective cooling performance. Particularly, in recent years, as the capacity of a battery module or battery pack increases, the amount of heat generation increases. With such heating, a water-cooled cooling structure rather than an air-cooled cooling structure is required to control the increased heat generation amount. In the case of a water-cooled cooling structure, cooling performance is typically excellent, but a sealed structure that prevents cooling water from leaking to electrical components inside a battery pack may be required.

As the demand for increased battery pack capacity and improved heat dissipation performance increases, it becomes necessary to develop a battery pack equipped with a stable sealed structure.

### SUMMARY

### Technical Problem

It is an object of the present disclosure to provide a battery pack which is improved in sealing property to prevent coolant leakage in a water-cooled cooling structure, and a device including the same.

However, the problem to be solved by embodiments of the present disclosure is not limited to the above-described problems, and can be variously expanded within the scope of the technical idea included in the present disclosure.

### Technical Solution

According to one embodiment of the present disclosure, there is provided a battery pack comprising: a battery module including a plurality of battery cells; a pack frame that houses the battery module; a pack coolant pipe assembly that is connected to the battery module; and a pack coolant pipe housing that houses the pack coolant pipe assembly therein. The pack coolant pipe housing includes a lower part configurable between an open position and a closed position, and the pack coolant pipe assembly is located between the pack coolant pipe housing and the pack frame.

The pack coolant pipe housing may comprise a housing part in which the pack coolant pipe assembly is housed and the lower part is opened, and a fastening part that extends from the housing part and is fastened to the pack frame.

The battery pack may further comprise a gasket that is located between the fastening part and the pack frame.

The fastening part may be fastened to the pack frame by bolt joining.

The battery pack may comprise a battery cell stack in which the battery cells are stacked; a module frame that houses the battery cell stack; a heat sink that is located under the bottom part of the module frame; and cooling ports that supply a coolant to the heat sink or discharge the coolant from the heat sink.

The module frame may comprise a module frame protrusion that protrudes from a bottom part of the module frame, the cooling port may be located on the module frame protrusion; and the pack coolant pipe assembly may be connected to the cooling port.

The battery module may comprise a first battery module and a second battery module. The module frame protrusion of the first battery module may protrude toward the second battery module. The module frame protrusion of the second battery module may protrude toward the first battery module.

The pack coolant pipe assembly and the pack coolant pipe housing may be located between the first battery module and the second battery module, and the pack coolant pipe assembly may be connected to the cooling port through an opened lower part of the pack coolant pipe housing.

The bottom part of the module frame may constitute an upper plate of the heat sink, and the bottom part of the module frame may come into contact with the coolant.

The pack coolant pipe assembly may comprise a pack coolant pipe and a connection port that connects the pack coolant pipe and the cooling port.

The cooling port may be inserted therein and coupled to the lower side of the connection port, and a sealing member may be located between the cooling port and the connection port.

The battery pack may further comprise a drain valve that is formed in a region covered by the pack coolant pipe housing and has an openable and closable structure.

The drain valve may comprise a spacer in which a connection pipe is formed, and a drain plug inserted into the connection pipe.

The battery pack may further comprise a leak detection sensor that is housed in the pack coolant pipe housing.

### Advantageous Effects

According to embodiments of the present disclosure, cooling performance can be improved through the integrated structure in which the module frame and the heat sink are integrated. A cooling port is formed in each of the battery modules in the battery pack, so that uniform cooling performance can be exhibited in each battery module.

In addition, a pack coolant pipe assembly that transfers the coolant to the cooling port is housed in the pack coolant pipe housing, thereby being able to prevent leaked coolant from penetrating electric components inside the battery pack and causing a fire or explosion.

Further, since the pack coolant pipe housing in a shape a lower part is opened is used, the number of required parts can be reduced, and the region requiring sealing can be reduced, thereby reducing the risk of coolant leakage.

The effects of the present disclosure are not limited to the effects mentioned above and additional other effects not described above will be clearly understood from the description of the appended claims by those skilled in the art.

### DESCRIPTION OF THE DRAWINGS

FIG. 1 is a perspective view of a battery module according to one embodiment of the present disclosure.

FIG. 2 is an exploded perspective view of the battery module of FIG. 1.

FIG. 3 is a plan view of a battery cell included in the battery module of FIG. 2.

FIG. 4 is a perspective view of the battery module of FIG. 1 as viewed from below to above along the Z-axis direction.

FIG. 5 is an exploded perspective view of a battery pack according to one embodiment of the present disclosure.

FIG. 6 is an exploded perspective view of a battery pack according to one embodiment of the present disclosure excluding a pack coolant pipe housing.

FIG. 7 is a perspective view of a pack coolant pipe assembly, a pack coolant pipe housing, and a gasket according to one embodiment of the present disclosure.

FIG. 8 is a perspective view of portions of each of a battery module, a pack coolant pipe assembly, and a pack coolant pipe housing according to one embodiment of the present disclosure.

FIG. 9 is a perspective view of a connection port and a cooling port according to one embodiment of the present disclosure.

FIG. 10 is a perspective view of a pack coolant pipe housing according to one embodiment of the present disclosure.

FIG. 11 is a perspective view of the opened lower part of the pack coolant pipe housing of FIG. turned upside down.

FIG. 12 is a cross-sectional view taken along line A-A′ of FIG. 5 when the pack coolant pipe housing and the pack coolant pipe assembly are arranged between the battery modules.

FIG. 13(a) is an enlarged cross section view of region “B” of FIG. 12.

FIG. 13(b) is a perspective view of region “B” of FIG. 12.

FIG. 14 is a perspective view of a pack coolant pipe assembly, a pack coolant pipe housing, and a pack coolant pipe cover according to another example of the present disclosure.

### DETAILED DESCRIPTION OF THE PREFERRED EMBODIMENTS

Hereinafter, various embodiments of the present disclosure will be described in detail with reference to the accompanying drawings so that those skilled in the art can easily ascertain the various embodiments. The present disclosure may be modified in various ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings, including details such as the sizes and thicknesses of each element as illustrated in the drawings.

In addition, it will be understood that when an element such as a layer, film, region, or plate is referred to as being “on” or “above” another element, it can be directly on the other element or intervening elements may also be present. In contrast, when an element is referred to as being “directly on” another element, it includes arrangements where other intervening elements may not be present. Further, the word “on” or “above” includes arrangements on or below a reference portion, and does not necessarily mean being disposed on the upper end of the reference portion toward the opposite direction of which a gravitational force acts on the object.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

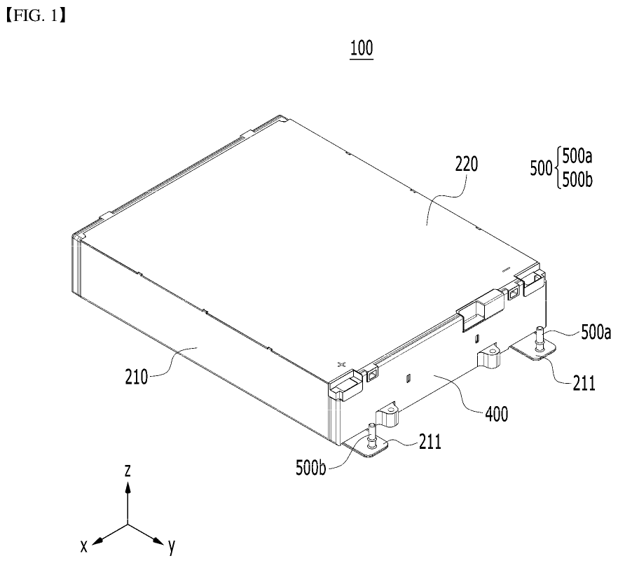

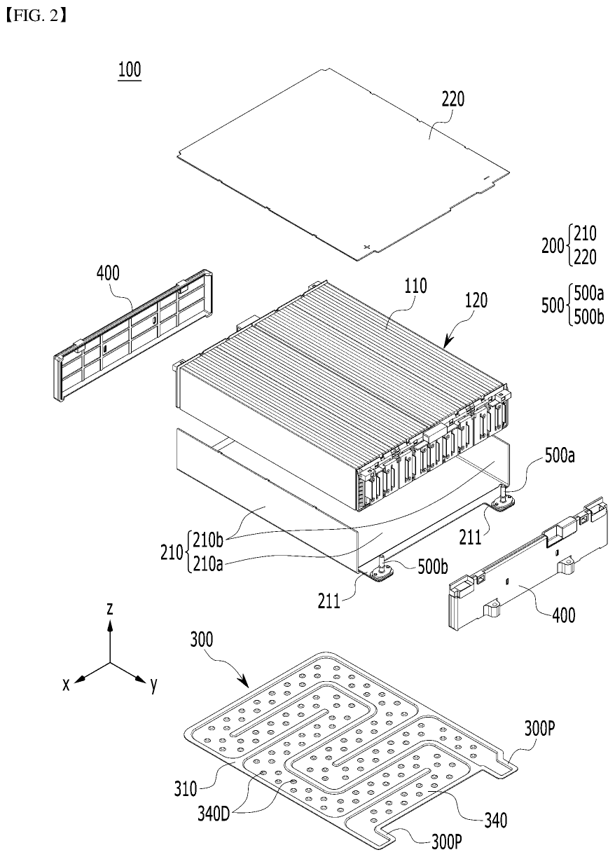

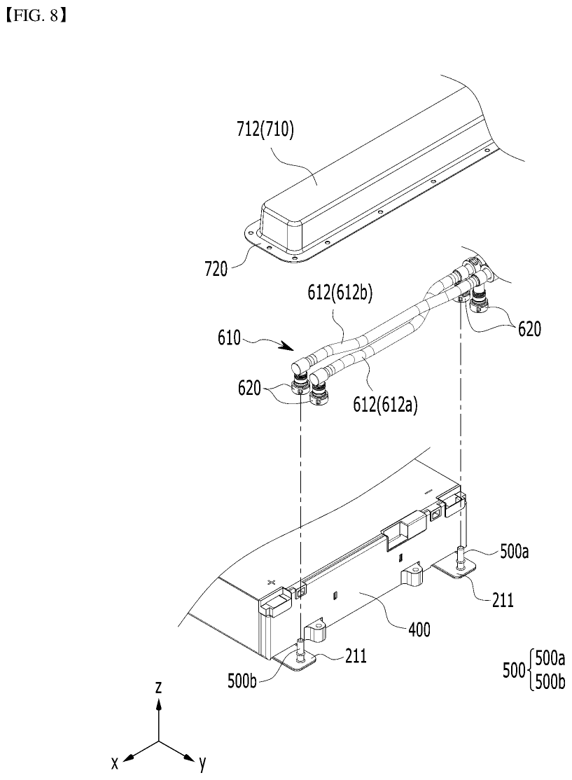

FIG. 1 is a perspective view showing a battery module according to one embodiment of the present disclosure. FIG. 2 is an exploded perspective view of the battery module of FIG. 1. FIG. 3 is a plan view of a battery cell included in the battery module of FIG. 2.

Referring to FIGS. 1 to 3, the battery module 100 according to one embodiment of the present disclosure includes a plurality of battery cells 110. Specifically, the battery module 100 may include a battery cell stack 120 in which battery cells 110 are stacked and a module frame 200 that houses the battery cell stack 120.

The battery cell 110 may be a pouch-type battery cell. Such a pouch-type battery cell may be formed by housing an electrode assembly in a pouch case of a laminated sheet including a resin layer and a metal layer, and then fusing the outer peripheral part of the pouch case. At this time, the battery cells 110 may be formed in a rectangular sheet-like structure as shown in FIG. 3.

Specifically, the battery cell 110 according to the present embodiment has a structure in which two electrode leads 111 and 112 face each other and protrude from one end 114a and the other end 114b of the cell main body 113, respectively. The battery cell 110 can be produced by joining both ends 114a and 114b of a cell case 114 and one side part 114c connecting them in a state in which an electrode assembly (not shown) is housed in a cell case 114. In other words, the battery cell 110 according to one embodiment of the present disclosure has a total of three sealing parts, wherein the sealing parts have a structure that is sealed by a method such as heat-sealing, and the remaining other side part may be composed of a connection part 115. A longitudinal direction of the battery cell 110 may be defined between both ends 114a and 114b of the battery case 114. The width direction of the battery cell 110 may be defined between one side part 114c connecting both ends 114a and 114b of the battery case 114 and the connection part 115.

According to one embodiment, the battery cell 110 has a structure in which the electrode leads 111 and 112 protrude in both directions of both sides of the battery cell 110. In another embodiment of the present disclosure, a unidirectional pouch-type battery cell has a structure in which the electrode leads protrude together in one direction.

The battery cell 110 may include a plurality of battery cells, and the plurality of battery cells 110 may be stacked so as to be electrically connected to each other, thereby forming a battery cell stack 120. Particularly, as shown in FIG. 2, a plurality of battery cells 110 may be stacked along the direction parallel to the x-axis. The battery cell case 114 is generally formed in a laminated structure of resin layer/metal thin film layer/resin layer. For example, when the surface of the battery case is formed of an O (oriented)-nylon layer, it tends to slide easily due to external impact when stacking a plurality of battery cells to form a medium or large-sized battery module. Therefore, in order to prevent this sliding and maintain a stable stacked structure of battery cells, an adhesive member such as a cohesive-type adhesive like double-sided tape or a chemical adhesive bonded by chemical reaction during adhesion can be attached to the surface of the battery case to form a battery cell stack 120.

Referring to FIGS. 1, 2 and 4, the module frame 200 housing battery cell stack 120 may include a U-shaped frame 210 and an upper cover 220.

The U-shaped frame 210 may include a bottom part 210a and two side surface parts 210b extending upward at both ends of the bottom part 210a. The bottom part 210a may cover the lower surface of the battery cell stack 120, and the side surface part 210b may cover both side surfaces of the battery cell stack 120.

The upper cover 220 may be formed into a single plate-shaped structure that wraps the lower surface covered by the U-shaped frame 210 and the remaining upper surface (z-axis direction), but not both side surfaces. The upper cover 220 and the U-shaped frame 210 can be joined by welding or the like such that corresponding corner portions of the upper cover 220 and the U-shaped frame 210 are in contact with each other, thereby forming a structure that covers the battery cell stack 120 vertically and horizontally. The battery cell stack 120 can be physically protected through the upper cover 220 and the U-shaped frame 210. For this purpose, the upper cover 220 and the U-shaped frame 210 may include a metal material having a predetermined strength.

In another embodiment not depicted in the figures, module frames may be mono frame in the form of a metal plate in which the upper surface, the lower surface, and both side surfaces are integrated. Specifically the U-shaped frame 210 and the upper cover 220 are not coupled to each other, but rather, the upper surfaces, the lower surfaces, and the side surfaces are integrated by manufacturing processes such as extrusion molding.

The end plates 400 may be openly formed on both sides of the module frame 200 such that they oppose each other and cover the battery cell stack 120. Such an end plate 400 can physically protect the battery cell stack 120 and other electrical components from external impact.

A busbar frame to which a busbar is mounted and an insulating cover for electrical insulation may be located between the battery cell stack 120 and the end plate 400.

The battery module 100 according to the present embodiment may further include a heat sink 300 that is located under the bottom part 210a of the module frame 200. The bottom part 210a of the module frame 200 constitutes an upper plate of the heat sink 300, and the recessed part 340 of the heat sink 300 and the bottom part 210a of the module frame 200 may form a coolant flow path. Further, the battery module 100 may include cooling ports 500 that supply a coolant to the heat sink 300 or discharge the coolant from the heat sink.

Specifically, the module frame according to the present embodiment may comprise a module frame protrusion 211 that protrudes from the bottom part of the module frame 200 to pass the first end plate 400. Coolant may be supplied to or discharged from the heat sink 300 by the cooling port 500 located on the module frame protrusion 211. A pack coolant pipe assembly described below may be connected to the cooling port 500.

The cooling port 500 may include a coolant injection port 500a that supplies a coolant to the heat sink 300 and a coolant discharge port 500b that discharges the coolant from the heat sink 300. The coolant injection port 500a and the coolant discharge port 500b may be connected to a pack coolant supply pipe and a pack coolant discharge pipe, such a connection is described below. The module frame protrusion 211 may include a first module frame protrusion and a second module frame protrusion, each located apart from each other at one side of the module frame 200. The coolant injection port 500a may be arranged on the first module frame protrusion, and the coolant discharge port 500b may be arranged on the second module frame protrusion.

The heat sink according to the present embodiment will be described in detail. As described above, the bottom part 210a of the module frame 200 constitutes an upper plate of the heat sink 300, and the recessed part 340 of the heat sink 300 and the bottom part 210a of the module frame 200 may correspond to a flow path through which coolant flows.

Specifically, the heat sink 300 may be formed at a lower part of the module frame 200. The heat sink 300 may include a lower plate 310 that forms the skeleton of the heat sink 300 and is directly joined to the bottom part 210a of the module frame 200 by welding or the like, and a recessed part 340 which forms a path through which coolant flows. In addition, the heat sink 300 may include heat sink protrusions 300P that protrude from one side of the heat sink 300 to a portion where the module frame protrusion 211 is located. That is, the recessed part 340 may connect the two heat sink protrusions 300P, wherein the two heat sink protrusions 300P may be a portion through which coolant flows in and a portion through which coolant is discharged, respectively. For this purpose, the heat sink protrusion 300P may be located to correspond to the module frame protrusion 211 on which the cooling port 500 is formed.

The heat sink protrusion 300P and the module frame protrusion 211 may be directly joined to each other by welding or the like.

The recessed part 340 of the heat sink 300 corresponds to a portion in which the lower plate 310 is recessed downward. The recessed part 340 may be a pipe having a U-shaped cross section cut along an xz plane or an yz plane perpendicular to the direction in which the coolant flow path extends, and the bottom part 210a may be located on the opened upper side of the U-shaped pipe. While the lower plate 310 of the heat sink 300 is in contact with the bottom part 210a, the space between the recessed part 340 and the bottom part 210a becomes an area in which coolant flows, that is, a flow path for the coolant. Thereby, the bottom part 210a of the module frame 200 may come into direct contact with the coolant.

The method for preparing the recessed part 340 of the heat sink 300 is not particularly limited. The U-shaped recessed part 340 having an opened upper side can be formed by providing a structure in which the plate-shaped heat sink 300 is formed to be recessed.

The recessed part 340 may extend from one of the heat sink protrusions 300P to the other as described above. The coolant supplied through the coolant injection port 500a passes between the module frame protrusion 211 and the heat sink protrusion 300P and first flows into the space between the recessed part 340 and the bottom part 210a. After that, the coolant moves along the recessed part 340, passes between the other module frame protrusion 211 and the other heat sink protrusion 300P and is discharged through the coolant discharge port 500b.

A thermal conductive resin layer including a thermal conductive resin may be located between the bottom part 210a of the module frame 200 and the battery cell stack 120 illustrated in FIG. 2. The thermal conductive resin layer can be formed by applying a thermal conductive resin to the bottom part 210a and then curing the applied thermal conductive resin.

The thermal conductive resin may include a thermal conductive adhesive material, and specifically, may include at least one of a silicone material, a urethane material, and an acrylic material. The thermal conductive resin is applied as a liquid, but cures after application to fix together one or more battery cells 110 constituting the battery cell stack 120. Further, because the thermal conductive resin generally has excellent heat transfer properties, heat generated in the battery module 110 may be quickly transferred to the lower-side.

The battery module 100 according to the present embodiment includes a cooling integrated type structure of the module frame 200 and the heat sink 300 and thus, can further improve the cooling performance. The bottom part 210a of the module frame 200 corresponds to the upper plate of the heat sink 300, thereby resulting in a cooling integrated type structure. The cooling efficiency increases due to direct cooling. The space utilization rate of the battery module 100 and the battery pack 1000 to which the battery module 100 is mounted can be further improved through a structure in which the heat sink 300 is integrated with the bottom part 210a of the module frame 200.

Heat generated from the battery cell 110 can pass through a thermal conductive resin layer (not shown) located between the battery cell stack 120 and the bottom part 210a and/or between the bottom part 210a of the module frame 200 and the coolant, and then be transferred to the outside of the battery module 100. By removing the unnecessary cooling structure according to conventional battery structures, the heat transfer path can be simplified and an air gap between respective layers can be reduced, so that the cooling efficiency and performance may be enhanced. Particularly, more advantageous direct cooling through coolant is realized in embodiments of the present invention compared to existing structures because the bottom part 210a is composed of an upper plate of the heat sink 300, and the bottom part 210a directly abuts the coolant.

Further, through the removal of the unnecessary cooling structure, the height of the battery module 100 is reduced, which decreases costs and increase space utilization. Furthermore, since the battery module 100 can be arranged in a compact manner, the capacity or output of the battery pack including a plurality of battery modules 100 can be increased.

Meanwhile, the bottom part 210a of the module frame 200 may be welded to the lower plate 310 portion where the recessed part 324 is not formed in the heat sink 300. In the present embodiment, the cooling integrated type structure of the bottom part 210a of the module frame 200 and the heat sink 300 not only improve the above-mentioned cooling performance, but also have the effect of supporting the load of the battery cell stack 120 housed in the module frame 200 and reinforcing the stiffness of the battery module 100. In addition, the lower plate 310 and the bottom part 210a of the module frame 200 are sealed through welding or other joining methods, so that coolant can flow in the recessed part 340 formed inside the lower plate 310 without leaking.

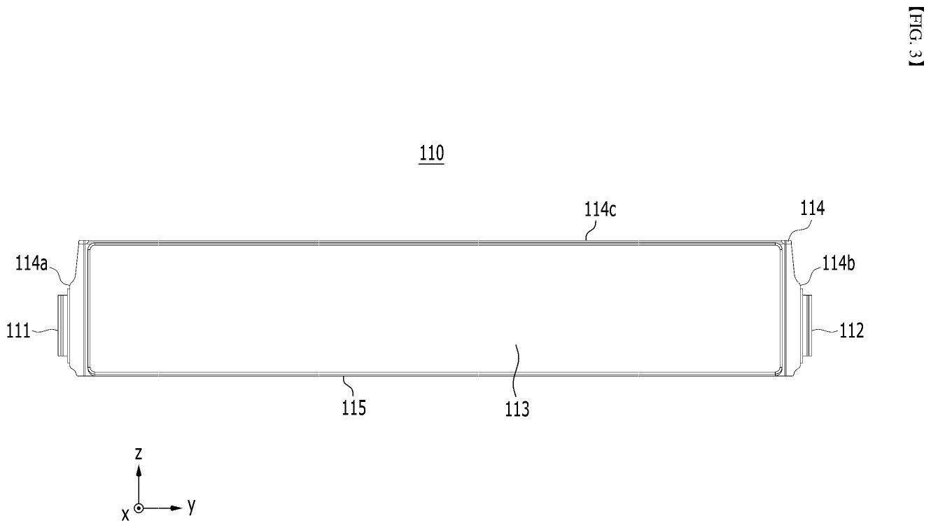

For effective cooling, as shown in FIG. 4, the recessed part 340 is preferably formed over the entire area corresponding to the bottom part 210a of the module frame 200 as shown in FIG. 4. For this purpose, the recessed part 340 may be bent at least once along its length. Particularly, in order for the recessed part 340 to form over the entire area corresponding to the bottom part 210a of the module frame 200, the recessed part 340 is preferably bent several times. As the coolant moves from the start point to the end point of the coolant flow path formed over the entire region corresponding to the bottom part 210a of the module frame 200, efficient cooling can be achieved over the entire region of the battery cell stack 120.

The coolant may be cooling water or other mediums for cooling. As such, the battery pack 1000 according to the present embodiment may have a water-cooled type cooling structure.

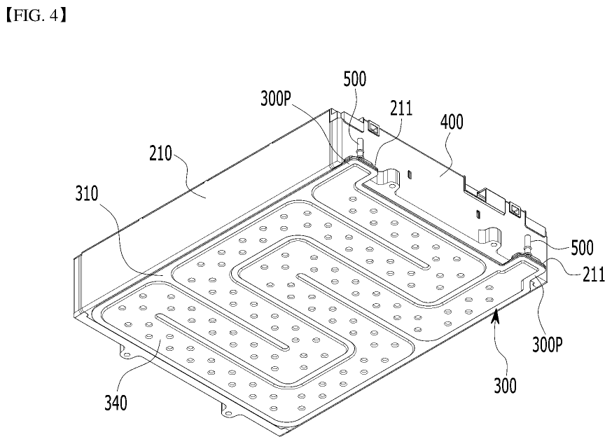

Next, a battery pack according to one embodiment of the present disclosure will be described in detail with reference to FIGS. 5 to 7.

Referring to FIGS. 5 to 7, the battery pack 1000 according to one embodiment of the present disclosure includes a battery module 100; a pack frame 1100 that houses the battery module 100; a pack coolant pipe assembly 600 that is connected to the battery module 100; and a pack coolant pipe housing 700 that houses the pack coolant pipe assembly 600 therein. The pack coolant pipe housing 700 has a shape in which the lower part is opened. The battery module 100 previously described in FIGS. 1 to 4 may be housed in the pack frame 1100.

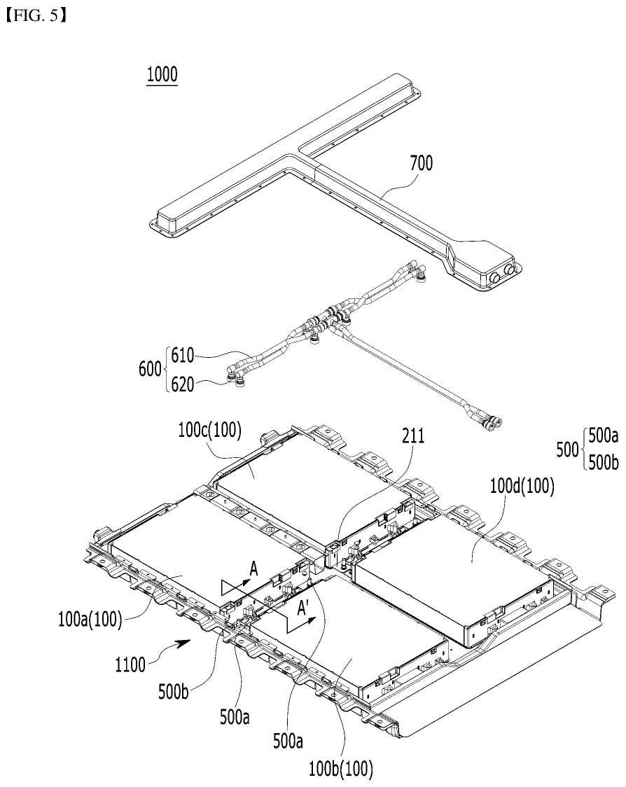

The number of battery modules 100 included in the battery pack 1000 is not particularly limited. One battery module may be arranged, and a plurality of battery modules may be arranged. As an example, as shown in FIGS. 5 and 6, four battery modules 100 may be arranged in a lattice form. The plurality of battery modules 100 are arranged in two rows in the direction in which the battery cells 110 are stacked, and may include a first battery module 100a and a second battery module 100b that face each other in a direction perpendicular to the direction in which the battery cells 110 are stacked. Further, in the direction in which the battery cells 110 are stacked, a third battery module 100c may be located next to the first battery module 100a, and a fourth battery module 100d may be located next to the second battery module 100b.

In the present embodiment, the pack coolant pipe assembly 600 may be connected to the cooling ports 500 of the battery module 100. Further, the pack coolant pipe assembly 600 may be arranged between the battery modules 100 adjacent to each other. As shown in FIGS. 5 and 6, all of the cooling ports 500 formed in each of the battery modules 100 adjacent to each other can be arranged in the space between the battery modules 100 adjacent to each other in which the pack coolant pipe assembly 600 is arranged. Specifically, referring to FIGS. 1, 5, and 6, the module frame protrusion 211 of the first battery module 100a may protrude toward the second battery module 100b, and the module frame protrusion 211 of the second battery module 100b may protrude toward the first battery module 100a. In such an arrangement, both the cooling ports 500 of the first battery module 100a and the cooling ports 500 of the second battery module 100b may be located between the first battery module 100a and the second battery module 100b. Thereby, a portion of the pack coolant pipe assembly 600 connected to the cooling ports 500 may be located between the first battery module 100a and the second battery module 100b. Further, a portion of the pack coolant pipe housing 700 that houses the pack coolant pipe assembly 600 may also be located between the first battery module 100a and the second battery module 100b. The pack coolant pipe assembly 600 may be connected to the cooling ports 500 through an opened bottom part of the pack coolant pipe housing 700. The connection structure between the pack coolant pipe assembly 600 and the cooling port 500 and the structure of the pack coolant pipe housing 700 is described again below.

The coolant injection port 500a formed in one of the battery modules 100 adjacent to each other and the coolant discharge port 500b formed in the other battery module 100 may be arranged facing each other. In one example, the coolant injection port 500a of the first battery module 100a and the coolant discharge port 500b of the second battery module 100b may be arranged to face each other.

The pack coolant pipe assembly 600 may include a pack coolant pipe 610 and a connection port 620 for connecting the pack coolant pipe 610 and the cooling port 500.

The pack coolant pipe 610 may include a main pack coolant pipe 611 that is connected to an inlet 910 and an outlet 920 and a sub-pack coolant pipe 612 that connects between the main pack coolant pipe 611 and the battery module 100. The sub-pack coolant pipe 612 may each extend in both directions perpendicular to the longitudinal direction of the main pack coolant pipe 611 at one end of the main pack coolant pipe 611.

In particular, the sub-pack coolant pipe 612 may be connected to the cooling ports 500 of the battery module 100 through the connection port 620. Further, the sub-pack coolant pipes 612 may extend while crossing each other. One of the crossed sub-pack coolant pipes 612 may be a sub-pack coolant supply pipe 612a, and the other may be a sub-pack coolant discharge pipe 612b.

The pack coolant pipe 610 according to the present embodiment described above results in a cooling integrated type structure with the battery module 100 within the battery pack 1000. Thus, the space utilization rate can be increased while simultaneously improving the cooling efficiency. The height of the crossed sub-pack coolant supply pipe 612a and the height of the sub-pack coolant discharge pipe 612b may be different from each other so as to have the arrangement structure of the pack coolant pipe 610 described above. The height of the sub-pack coolant supply pipe 612a and the height of the sub-pack coolant discharge pipe 612b may be different from each other only in some portions.

The main pack coolant pipe 611 may include a main pack coolant supply pipe 611a and a main pack coolant discharge pipe 611b. The main pack coolant supply pipe 611a may be connected to the sub-pack coolant supply pipe 612a, and the main pack coolant discharge pipe 611b may be connected to the sub-pack coolant discharge pipe 612b.

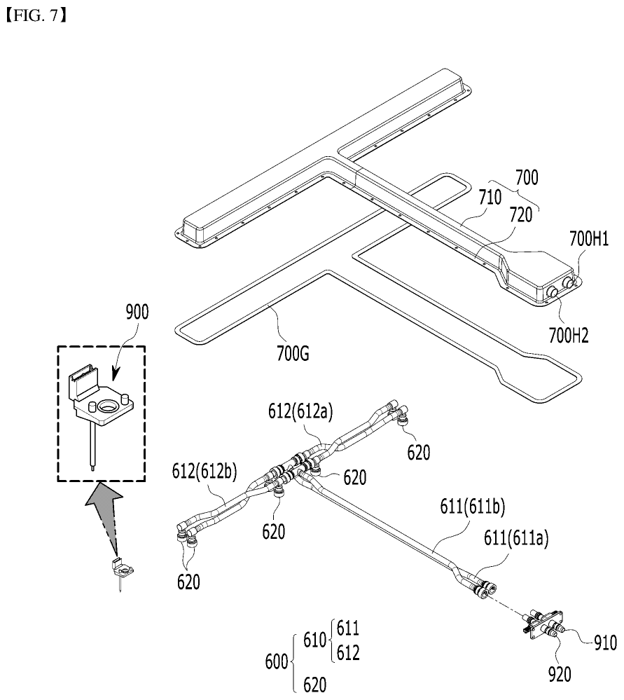

Referring to FIGS. 5 to 9 together, the connection port 620 may connect the cooling port 500 and the pack coolant pipe 610. As described above, the cooling port 500 may include a coolant injection port 500a and a coolant discharge port 500b, and the pack coolant pipe 610 may include a sub-pack coolant supply pipe 612a and a sub-pack coolant discharge pipe 612b.

Any one connection port 620 may connect between the coolant injection port 500a and the sub-pack coolant supply pipe 612a. Also, another connection port 620 may connect the coolant discharge port 500b and the sub-pack coolant discharge pipe 612b. That is, the connection port 620 is connected to each of the coolant injection ports 500a that supply coolant to the plurality of battery modules 100, and each of the coolant discharge ports 500b that discharge the coolant from the plurality of battery modules 100.

Taken together with the structure of the heat sink 300 described above, the coolant passes through the inlet 910, the main pack coolant supply pipe 611a, the sub-pack coolant supply pipe 612a, the connection port 620, and the coolant injection port 500a in order, and flows into the heat sink 300 of the battery module 100. The coolant flowing along the heat sink 300 cools the heat generated from the battery module 100. After that the coolant flows along heat sink 300, the coolant first passes through the coolant discharge port 500b, then the connection port 620, the sub-pack coolant discharge pipe 612b, the main pack coolant discharge pipe 611b and the outlet 920, and is discharged to the outside of the battery pack 1000. As described above, the coolant circulation structure of the battery pack 1000 according to the present embodiment is provided.

The sub-pack coolant pipe 612 may be located between the first battery module 100a and the second battery module 100b and between the third battery module 100c and the fourth battery module 100d. Further, the sub-pack coolant pipe 612 may be connected to the cooling ports 500 of each of the first to fourth battery modules 100a, 100b, 100c, and 100d. The main pack coolant pipe 611 may be located between the second battery module 100b and the fourth battery module 100d.

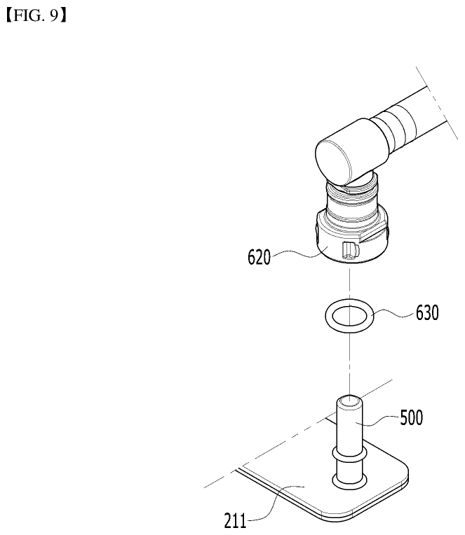

Meanwhile, a connection method between the connection port 620 and the cooling port 500 is not particularly limited. As an example, as shown in FIG. 9, the cooling port 500 may be inserted therein and coupled to the lower side of the connection port 620. A lower end of the connection port 620 may come into contact with an upper surface part of the module frame protrusion 211. The cooling port 500 and the connection port 620 may be coupled in a shape in which the cooling port 500 is inserted into the connection port 620.

A sealing member 630 may be located between the cooling port 500 and the connection port 620. The sealing member 630 may have an O-ring shape, and may be inserted between the cooling port 500 and the connection port 620. While the sealing member 630 being inserted into the cooling port 500, it may be inserted into the connection port 620 together with the cooling port 500. The sealing member 630 can prevent the coolant from leaking through a gap between the cooling port 500 and the connection port 620.

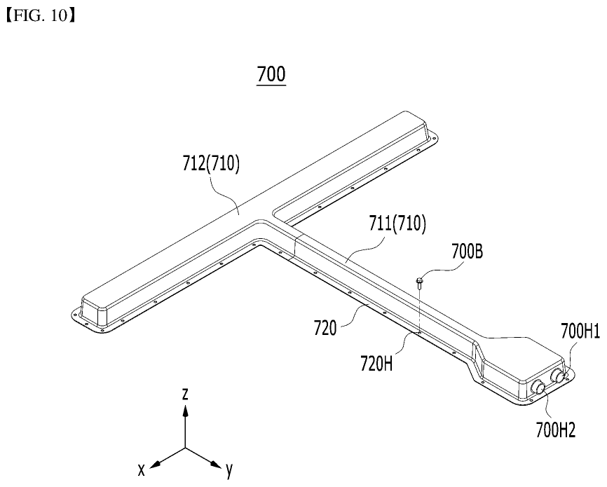

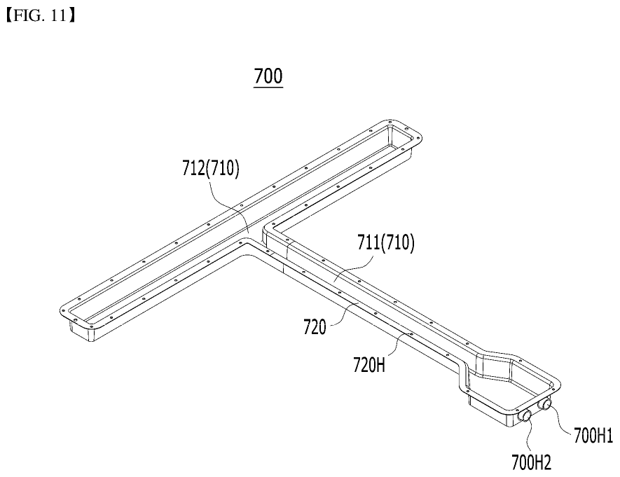

The pack coolant pipe housing according to the present embodiment will be described in detail with reference to FIGS. 5, 7, 8, and 10 to 12.

Referring to FIGS. 5, 7, 8 and 10 to 12, the battery pack 1000 according to the present embodiment includes a pack coolant pipe housing 700 that houses the pack coolant pipe assembly 600 therein. The pack coolant pipe housing 700 is shaped so that the lower part is opened. That is, the pack coolant pipe housing 700 may be configured such that a lower part is opened and an upper surface part and a side surface part are closed.

The pack coolant pipe assembly 600 is located between the pack coolant pipe housing 700 and the pack frame 1100. The pack coolant pipe housing 700 may extend along the extended portions of the main pack coolant pipe 611 and the sub-pack coolant pipe 612.

Specifically, the pack coolant pipe housing 700 may include a housing part 710 that houses the pack coolant pipe assembly 600 and is opened in its lower part, and a fastening part 720 that extends from the housing part 710 and is fastened to the pack frame 1100. That is, the housing part 710 may be configured to connect to the side surface part and the upper surface part, and the fastening part 720 may be configured to extend side by side on one surface of the pack frame 1100.

The fastening part 720 may be fastened to the pack frame 1100 through bolt coupling. Specifically, a fastening hole 720H may be formed in the fastening part 720, and the bolt 700B may pass through the fastening hole 720H to be fastened to the pack frame 1100, so that the fastening part 720 can be coupled to the pack frame 1100. Thereby, the pack coolant pipe assembly 600 may be sealed between the pack coolant pipe housing 700 and the pack frame 1100. A hole (not shown) corresponding to the fastening hole 720H may be formed in the gasket 700G so that the bolt 700B can pass therethrough.

At this time, the battery pack 1000 according to the present embodiment may further include a gasket 700G that is located between the fastening part 720 and the pack frame 1100. This arrangement may prevent the coolant from leaking between the fastening part 720 of the pack coolant pipe housing 700 and the pack frame 1100.

As described above, the pack coolant pipe assembly 600 may include a main pack coolant pipe 611 and a sub-pack coolant pipe 612, and the housing part 710 of the pack coolant pipe housing 700 according to the present embodiment may include a first housing part 711 that houses the main pack coolant pipe 611 and a second housing part 712 that houses the sub-pack coolant pipe 612.

Further, as described above, the main pack coolant pipe 611 may be connected to the inlet 910 and the outlet 920. At this time, the pack coolant pipe housing 700 may include an inlet hole 700H1 and an outlet hole 700H2 formed at locations corresponding to the inlet 910 and the outlet 920, respectively. That is, the inlet 910 passes through the inlet hole 700H1 and is connected to the main pack coolant supply pipe 611a, and the outlet 920 may pass through the outlet hole 700H2 and is connected to the main pack coolant discharge pipe 611b. Although not specifically shown in the figure, the inlet 910 and the outlet 920 may be connected to an external coolant circulation system.

In the present embodiment, the battery pack 1000 having the pack coolant pipe assembly 600 can be applied to vehicle means such as electric vehicles and hybrid vehicles, but a situation may occur in which coolant such as cooling water may leak due to an assembly failure or an accident during operation. The leaked coolant penetrates into a plurality of parts constituting the battery pack 1000, which may cause a fire or explosion. Thus, the pack coolant pipe assembly 600 is configured to be sealed between the pack coolant pipe housing 700 and the pack frame 1100, whereby even if the coolant leaks from the pack coolant pipe assembly 600, it remains inside the pack coolant pipe housing 700. Thus, coolant is prevented from leaking from the pack coolant pipe assembly 600 permeates other parts in the battery pack 1000. Preferably, the space between the plurality of battery modules 100 is utilized so that the pack coolant pipe housing 700 can house the leaked coolant to a maximum extent, thereby utilizing the volume of the pack coolant pipe housing 700.

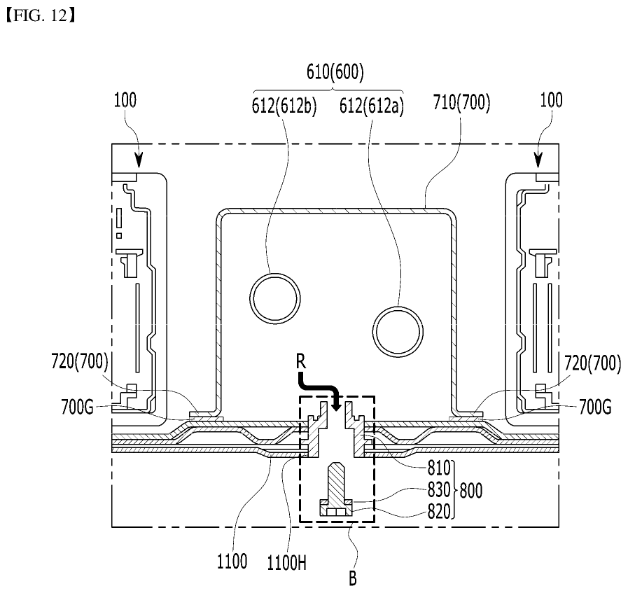

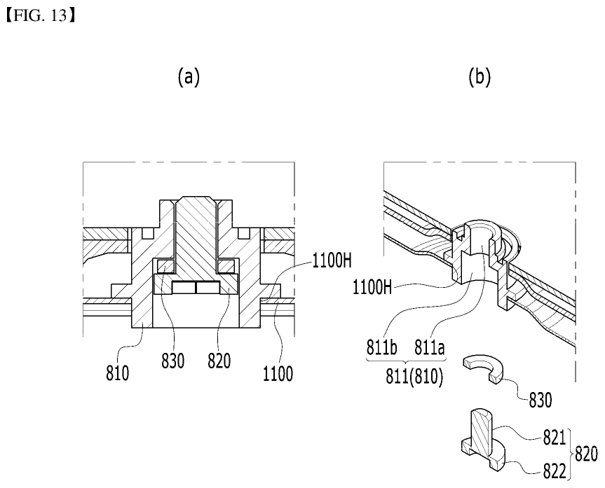

Next, a drain valve according to a modified embodiment of the present disclosure will now be described in detail with reference to FIGS. 12 and 13.

Referring to FIGS. 12 and 13(a) and (b), the battery pack 1000 according to a modified embodiment of the present disclosure may further include a drain valve 800 having an openable and closable structure. The drain valve 800 may be formed in a region covered by the pack coolant pipe housing 700. A discharge port 1100H may be formed in the pack frame 1100, and a drain valve 800 may be located at the discharge port 1100H.

The drain valve 800 may include a spacer 810 in which a connection pipe 811 is formed, and a drain plug 820 that is inserted into connection pipe 811. This configuration allows the drain valve 800 to form an openable and closable structure.

The connection pipe 811 of the spacer 810 may include a first connection pipe 811a and a second connection pipe 811b, and the inner diameter of the first connection pipe 811a may be smaller than the inner diamerter of the second connection pipe 811b. The drain plug 820 may include an insertion part 821 having a diameter corresponding to the inner diameter of the first connection pipe 811a and a fixing part 822 having a diameter corresponding to the inner diameter of the second connection pipe 811b.

The insertion part 821 of the drain plug 820 can be inserted into the first connection pipe 811a of the spacer 810 to close the drain valve 800. The fixing part 822 is prevented from being inserted into the first connection pipe 811a, thereby preventing the drain plug 820 from entering the inner space of the pack coolant pipe housing 700.

The drain valve 800 may further include a sealing ring 830 located between the spacer 810 and the drain plug 820. Specifically, the sealing ring 830 is inserted into the insertion part 821, and then may be located between the step formed by the first connection pipe 811a and the second connection pipe 811b and the fixing part 822. By providing the sealing ring 830, while the insertion part 821 being inserted into the first connecting pipe 811a, coolant is prevented from leaking through the gap therebetween.

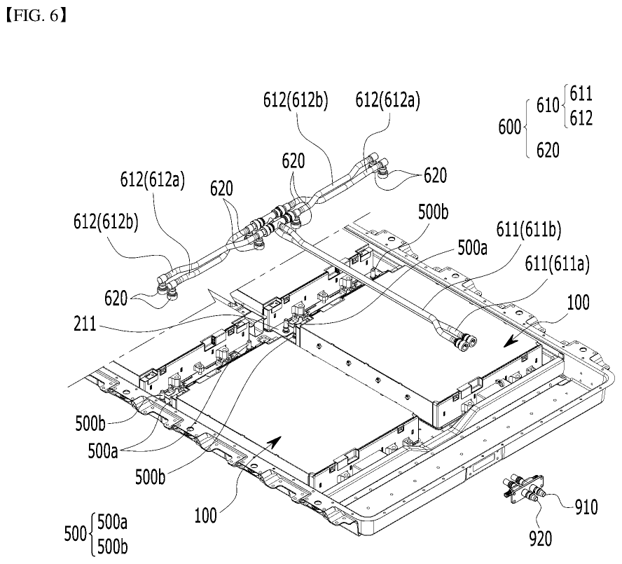

If the coolant (R) leaks from the pack coolant pipe assembly 600, the coolant R is collected on the bottom surface of the pack frame 1100 inside the pack coolant pipe housing 700. When this happens, the drain plug 820 can be removed from the connection pipe 811 to discharge the leaked coolant R to the outside of the pack frame 1100. Particularly, referring to FIG. 7, the battery pack 1000 according to the present embodiment may further include a leak detection sensor 900 housed in the pack coolant pipe housing 700. Particularly, the leak detection sensor 900 extends from the inner space of the pack coolant pipe housing 700 to the bottom surface of the pack frame 1100, and can detect the coolant R collected on the bottom surface of the pack frame 1100. When coolant leaks from the pack coolant pipe assembly 600, the leaked coolant R is collected on the bottom surface of the pack frame 1100. The leak detection sensor 900 may detect the leaked coolant R and send a signal. In accordance with this signal, the drain plug 820 is pulled out from the spacer 810, and the coolant R can be discharged to the outside of the pack frame 1100. That is, according to the present embodiment, while the coolant leaking from the pack coolant pipe assembly 600 through the pack coolant pipe housing 700 is prevented from penetrating into other components in the battery pack 1000, the coolant leaked through the drain valve 800 and the leak detection sensor 900 may be discharged to the outside of the battery pack 1000. Through the process described above, it is possible to prevent leakage of the coolant which may cause a fire or explosion of the battery pack 1000.

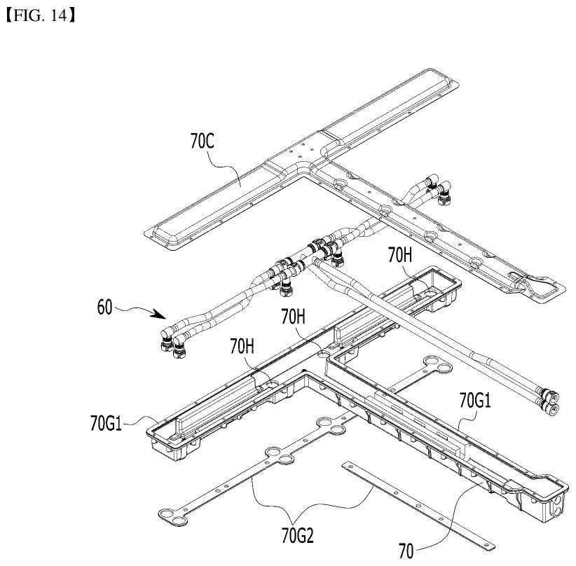

Next, the advantages of the pack coolant pipe housing of the present disclosure will be described in detail in comparison with the pack coolant pipe housing and the pack coolant pipe cover according to the comparative example of the present disclosure shown in FIG. 14.

Referring to FIG. 14, the pack coolant pipe assembly 60 is housed between the pack coolant pipe housing 70 and the pack coolant pipe cover 70C according to another example of the present disclosure. Specifically, the pack coolant pipe housing 70 may be opened in its upper part, and a pack coolant pipe cover 70C may cover the opened upper part of the pack coolant pipe housing 70.

In order to prevent leakage of the coolant, a first gasket 70G1 is preferably located between the pack coolant pipe housing 70 and the pack coolant pipe cover 70C. Further, a through hole may be formed in the lower surface of the pack coolant pipe housing 70 so that the cooling port 500 (see FIG. 2) can pass therethrough. A second gasket 70G2 may further be located under the pack coolant pipe housing 70 to prevent leakage of coolant from the through holes 70H.

To achieve a sealed structure of the pack coolant pipe assembly according to previous embodiments described above, two parts of the pack coolant pipe housing 70 and the pack coolant pipe cover 70C are required, whereas in the present embodiment, one pack coolant pipe housing 700 having an opened lower part can be used. That is, by using the pack frame 1100 in the formation of the sealing structure of the pack coolant pipe assembly, the number of parts required for the coolant leak prevention structure can be reduced. In addition, in this comparative example, the gasket for sealing also requires two gaskets 70G1 and 70G2, whereas in the present embodiment, one gasket 700G is sufficient.

Because the number of parts such as housings and gaskets are reduced with the present embodiment, weight and costs can be reduced. Further, since the pack coolant pipe cover 70C is not needed, additional space utilization may be achieved in the space occupied by the pack coolant pipe cover 70C.

Further, in this comparative example, as the number of gaskets is increased, the assembling positions of the two gaskets 70G1 and 70G2 may be finely set in the process of connecting each part. Further, the increased number of gaskets 70G1 and 70G2 may cause the risk of coolant leakage to increase. Therefore, the battery pack 1000 having the pack coolant pipe housing 700 according to the preferred embodiment has advantages in that the manufacturing process is simplified and the risk of coolant leakage is reduced, as compared to the comparative example.

At least a portion of the housing part 710 of the pack coolant pipe housing 700 according to the present embodiment may come into direct contact with the adjacent battery module 100. The cooling performance of the battery module 100 can be improved when at least a portion of the housing part 710 in which the pack coolant pipe assembly 600 is housed comes into contact with the battery module 100.

One or more battery modules according to the present embodiment described above can be mounted together with various control and protection systems such as BMS (battery management system), a BDU (battery disconnect unit) and a cooling system to form a battery pack.

The battery pack can be applied to various devices. Specifically, it can be applied to vehicle means such as an electric bike, an electric vehicle, and a hybrid electric vehicle, or ESS (Energy Storage System), but is not limited thereto and can be applied to various devices capable of using a secondary battery.

The terms representing directions such as the front side, the rear side, the left side, the right side, the upper side, and the lower side have been used in the present embodiment, but the terms used are provided simply for convenience of description and may become different according to the position of an object, the position of an observer, or the like. Although preferred embodiments of the present disclosure have been shown and described above, the scope of the present disclosure is not limited thereto, and numerous changes and modifications can be devised by those skilled in the art using the principles of the invention defined in the appended claims, which also falls within the spirit and scope of the present disclosure.

### IDENTIFICATION OF SELECT REFERENCE NUMERALS

1000: battery pack
100: battery module
200: module frame
300: heat sink
500: cooling port
600: pack coolant pipe assembly
700: pack coolant pipe housing
710: housing part
720: fastening part

The battery pack can be applied to various devices. Specifically, it can be applied to vehicle means such as an electric bike, an electric vehicle, and a hybrid electric vehicle, or ESS (Energy Storage System), but is not limited thereto and can be applied to various devices capable of using a secondary battery.

Although preferred embodiments of the present disclosure have been shown and described above, the scope of the present disclosure is not limited thereto, and numerous changes and modifications can be devised by those skilled in the art using the principles of the invention defined in the appended claims, which also falls within the spirit and scope of the present disclosure.

### DESCRIPTION OF REFERENCE NUMERALS

1000: battery pack
100: battery module
200: module frame
300: heat sink
500: cooling port
600: pack refrigerant pipe assembly
700: pack refrigerant pipe housing
710: housing part
720: fastening part

1. A battery pack comprising:
a battery module including a plurality of battery cells;
a pack frame that houses the battery module;
a pack coolant pipe assembly connected to the battery module; and
a pack coolant pipe housing that houses the pack coolant pipe assembly therein and includes a lower part configurable between an open position and a closed position,
and
wherein the pack coolant pipe assembly is located between the pack coolant pipe housing and the pack frame.

2. The battery pack according to claim 1, wherein:
the pack coolant pipe housing comprises includes a housing part configured to house the pack coolant pipe assembly when the lower part is in an open position, and a fastening part extending from the housing part and fastened to the pack frame.

3. The battery pack according to claim 2, further comprising:
a gasket positioned between the fastening part and the pack frame.

4. The battery pack according to claim 2, wherein:
the fastening part is fastened to the pack frame by a bolt.

5. The battery pack according to claim 1, wherein:
the battery module includes
a battery cell stack in which the battery cells are stacked;
a module frame that houses the battery cell stack;
a heat sink positioned under a bottom part of the module frame; and
a cooling portion configured to supply a coolant to the heat sink or discharge the coolant from the heat sink.

6. The battery pack according to claim 5, wherein:
the module frame comprises a module frame protrusion extending from the bottom part of the module frame,
the cooling port is positioned on the module frame protrusion; and
the pack coolant pipe assembly is connected to the cooling port.

7. The battery pack according to claim 6, wherein:
the battery module comprises a first battery module and a second battery module,
the module frame protrusion of the first battery module extends toward the second battery module, and
a module frame protrusion of the second battery module extends toward the first battery module.

8. The battery pack according to claim 7, wherein:
the pack coolant pipe assembly and the pack coolant pipe housing are positioned between the first battery module and the second battery module, and
the pack coolant pipe assembly is connected to the cooling port through the lower part of the pack coolant pipe housing when the lower part is in the open position.

9. The battery pack according to claim 5, wherein:
the bottom part of the module frame includes an upper plate of the heat sink, and
the bottom part of the module frame contacts the coolant.

10. The battery pack according to claim 5, wherein:
the pack coolant pipe assembly comprises a pack coolant pipe and a connection port configured to connect the pack coolant pipe and the cooling port.

11. The battery pack according to claim 10, wherein:
the cooling port is inserted into the connection port and is coupled to a lower side of the connection port, and
a sealing member is positioned between the cooling port and the connection port.

12. The battery pack according to claim 1, further comprising:
a drain valve disposed in the pack frame such that the drain valve is covered by the pack coolant pipe housing the drain valve configurable between an open position and a closed position.

13. The battery pack according to claim 12, further comprising:
a drain plug, wherein the drain valve comprises a spacer, the spacer defining a connection pipe, and the drain plug insertable within the connection pipe.

14. The battery pack according to claim 1, further comprising:
a leak detection sensor housed within the pack coolant pipe housing.

15. A device comprising the battery pack as set forth in claim 1.
